(19) United States
(12) Patent Application Publication
(10) Pub. No.: US 2010/0058608 A1
(43) Pub. Date: Mar. 11, 2010

(54) Laundry Dryer and Controlling Method Thereof

(75) Inventors: Jung Wook Moon, Gyeongsangnam-do (KR); Young Jong Kim, Gyeongsangnam-do (KR); Young Bok Son, Gyeongsangnam-do (KR)

Correspondence Address: MCKENNA LONG & ALDRIDGE LLP, 1900 K STREET, NW, WASHINGTON, DC, 20006, US

(73) Assignee: LG ELECTRONICS INC., SEOUL (KR)

(21) Appl. No.: 12/309,483

(22) PCT Filed: Jul. 23, 2007
(86) PCT No.: PCT/KR2007/003535

§ 371 Date: Nov. 17, 2009

(30) Foreign Application Priority Data
Jul. 24, 2006 (KR) 10-2006-0069135

(51) Int. Cl. F26B 25/06

(52) U.S. Cl. 34/282; 34/202

(57) ABSTRACT

The present invention relates to a laundry dryer and a controlling method of a dryer, which can dry clothes, cloth items, beddings and laundry objects (hereinafter, laundry) efficiently. A dryer includes a cabinet in which laundry is placed, a low temperature air generation unit that generates relatively low temperature air supplied to the cabinet to dry the laundry, and a path through which the relatively low temperature air is supplied to the cabinet. in another aspect, a controlling method of a dryer includes generating relatively low temperature air, and drying laundry by using the relatively low temperature air.

### TECHNICAL FIELD

The present invention relates to a dryer. More specifically, the present invention relates to a laundry dryer and a controlling method of a dryer, which can dry clothes, cloth items, beddings and laundry objects (hereinafter, laundry) efficiently.

### BACKGROUND ART

Dryers are home appliances that are used to dry laundry by using hot air after washing. Dryers typically include drying tubs (commonly it is referenced to as drum), driving parts that rotate the drums, heating means that heat air inside the drums to produce hot air and blower units that suck or exhaust the air inside the drums.

Dryers may be categorized, based on a heating method of damp air, in other words, heating means, into an electricity-type dryer and a gas-type dryer. In the electricity-type dryer, air is heated by using electric resistance heat that is produced at an electric heater. In the gas-type dryer, air is heated by using heat that is produced by gas combustion.

Dryers may be categorized, based on a drying method, into an air exhaustion-type dryer and an air condensation-type dryer (in other words, circulation-type dryer).

In the air condensation-type dryer, air is heat-exchanged with laundry inside a drum and circulated to dry laundry without drawing external air. The damp air is heat-exchanged with external air in an auxiliary condenser and condensed water is exhausted outside. In the air exhaustion-type dryer, external air is drawn to produce hot air and damp air inside a drum is directly exhausted outside.

On the other hand, dryers may be categorized based on a method of introducing laundry into the dryer, into a top loading-type dryer and a front loading type. In the top loading-type dryer, laundry is introduced through a top of the dryer. In the front loading-type dryer, laundry is introduced through a front portion of the dryer.

### DISCLOSURE OF INVENTION

### Technical Problem

According to the conventional dryer, air is heated by a gas burner or an electric heater at the temperature higher than 100° C. and the heated hot air is supplied to a drum. As the drum is rotated and laundry is heat-exchanged with the hot air, the laundry is dried.

However, in the conventional dryer, there might be damage to fabric of laundry, because the laundry is heat-exchanged with the hot air heated higher than 100° C.

Furthermore, the drum of the conventional dryer might be tumbled during a drying course. As a result, there might be damage to fabric of laundry because of friction between the drum and the laundry or between laundries. Accordingly, delicate laundries such as knit, dress shirts and luxurious clothes are not appropriate to the conventional dryer. In addition, there might be lots of lint because of such friction and thus a lint filter for filtering the lint should be provided in the conventional dryer, which makes a structure of the conventional dryer complicated.

A still further, the gas-type dryer requires an auxiliary pipe work and the electricity-type dryer requires relatively much energy.

### Technical Solution

To solve the problems, the present invention is to provide a dryer and a controlling method of a dryer, which can efficiently prevent damage to laundry and wrinkles of laundry after being dried.

To achieve these objects and other advantages and in accordance with the purpose of the invention, as embodied and broadly described herein, a dryer includes a cabinet in which laundry is placed; a low temperature air generation unit that generates relatively low temperature air supplied to the cabinet to dry the laundry; and a path through which the relatively low temperature is supplied to the cabinet. The laundry may be placed in the cabinet in a state of being secured.

The low temperature air generation unit may be a heat pump. The relatively low temperature air may be circulated through the cabinet and the heat pump. The air that is heat-exchanged with the laundry in the cabinet (the heat-exchanged air) may pass an evaporator provided in the heat pump.

The dryer may further include a moisture injection unit that supplies moisture to the cabinet. The water injection unit may include a water supply source and a steam generator that generates steam from water supplied from the water supply source to supply the steam to the cabinet. Water condensed at the evaporator may be supplied to the water supply source.

An ironing unit may be provided in at least one of an inside and outside of the cabinet. The cabinet may be a module type that selectively combines plural modules.

In another aspect, a controlling method of a dryer includes generating relatively low temperature air; and drying laundry by using the relatively low temperature air. The laundry is dried in a state of being secured, when drying the laundry by using the relatively low temperature air.

### ADVANTAGEOUS EFFECTS

The dryer and the controlling method of the dryer according to the present invention may have following advantageous effects.

First, the laundry is dried by the relatively low temperature air, compared with the conventional dryer. As a result, damage to the laundry may be prevented, which might occur in the conventional dryer.

Furthermore, the laundry is dried, being secured in the cabinet by using hangers. As a result, damage to fabric may be prevented, which might occur because of friction between the drum and the laundry or friction between the laundries. It is possible to dry delicate fabric such as knit, dress shirts and luxurious clothes and to prevent lint caused by friction from being produced.

A still further, pipes are not necessary that are used in a gas-type dryer and thus the structure of the dryer according to the present invention may be simple. In addition, energy may be saved, compared with an electric heater used in an electricity-type dryer.

A still further, wrinkles that might be produced in the laundry after being dried may be prevented or removed efficiently. According to the present invention, wrinkles or crushing of fabric that remains after being dried may be also removed without additional ironing. In addition, it is possible to sterilize and to remove bad smell.

### BRIEF DESCRIPTION OF THE DRAWINGS

The accompanying drawings, which are included to provide further understanding of the disclosure and are incorporated in and constitute a part of this application, illustrate embodiments of the disclosure and together with the description serve to explain the principle of the disclosure.

In the drawings:

FIG. 1 is a perspective view schematically illustrating a dryer according to an embodiment;

FIG. 2 is a diagram schematically illustrating a structure of the dryer shown in FIG. 1 to explain a principle of the dryer;

FIG. 3 is a sectional view illustrating an example of an ironing unit shown in FIG. 1; and

FIG. 4 is a perspective view schematically illustrating another example of the ironing unit shown in FIG. 1.

### BEST MODE FOR CARRYING OUT THE INVENTION

Reference will now be made in detail to the specific embodiments of the present invention, examples of which are illustrated in the accompanying drawings. Wherever possible, the same reference numbers will be used throughout the drawings to refer to the same or like parts.

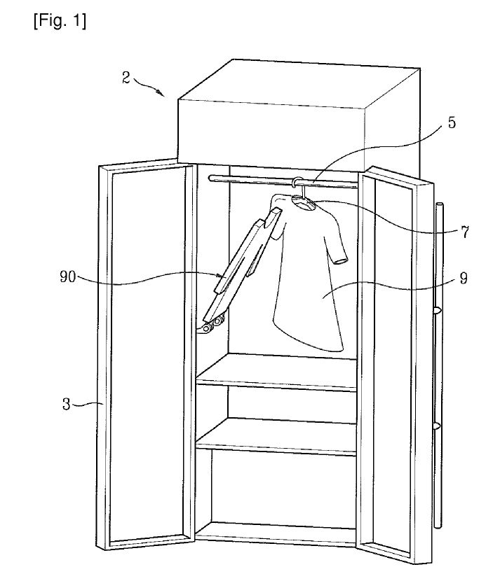

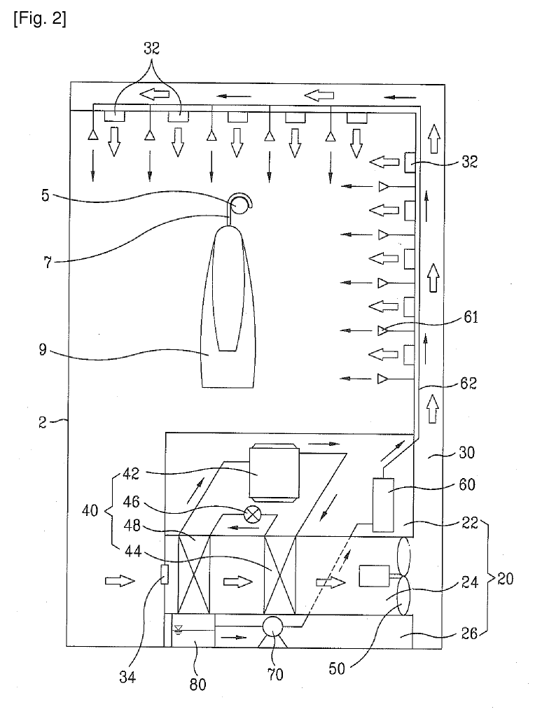

In reference to FIGS. 1 and 2, a preferred embodiment of a dryer and a controlling method thereof according to the present will be explained.

The dryer includes a cabinet 2 and a low temperature air generation unit 40. The cabinet 2 defines an exterior of the dryer and laundry is placed in the cabinet 2. The low temperature air generation unit 40 is provided in the cabinet 2 and it generates relatively lower temperature air, compared to the hot air in the conventional dryer (hereinafter, relatively low temperature air).

While air is heated by the gas burner or the electric heater higher than 100° C. in the conventional dryer, the dryer according to this embodiment heats air at the temperature of approximately 50˜70° C., which is relatively lower temperature, compared with the temperature of 100° C. in the conventional dryer. Here, the relatively low temperature may not mean that the temperature is low but means that it is relatively lower temperature, compared with the high temperature of the conventional dryer, although it is substantially high temperature.

While the drum is rotated in the conventional dryer, the laundry is placed and secured inside the cabinet 2 in the dryer according to the present invention. It is preferred that a supporting member 5 is provided within the cabinet 2. The laundry 9 is hung on hangers 7 and the hangers 7 are hanging on the supporting member 5. As a result, when drying the laundry 9, friction between the cabinet 2 and the laundry and friction between the laundries are prevented, according to the present invention.

The low temperature air generation unit 40 may be a gas burner or an electric heater. However, if the gas burner or the electric heater is used, a complex temperature control is necessary. It is preferred that the low temperature air generation unit is a heat pump 40.

In addition, in a gas-type dryer, air needed to combust air should be supplied from outside and the combusted air should be exhausted outside. If the gas-type dryer has a circulation structure, normal combustion is not performed continuously because of oxygen insufficiency and thus external exhaustion structure should be preferred. However, in case of an external exhaustion structure, a duct for exhaustion should be provided, which makes its structure complex.

Although an electricity-type heater may have an exhaustion structure, an auxiliary dehumidifier should be provided. Since an air cooled heat exchanger is used as dehumidifier, there should be provided a fan for supplying external air to an inside of a dryer and a duct for exhausting heat exchanged air to an outside, which makes the structure complex. In addition, as a matter of energy, a power factor of the electricity-type heater is 1 and it uses electricity that corresponds to the amount of heat. While, a heat pump uses a third of electricity that corresponds to the amount of heat requiring COP (Coefficient of Performance) of 3, which is more efficient than the electric heater.

In reference 2, the dryer that uses the heat pump 40 to produce relatively low temperature air will be explained.

The heat pump 40 is installed in a predetermined portion of the cabinet 2. The operational principle and structure of the heat pump 40 that includes the compressor 42, the condenser 44, the expansion part 46 and the evaporator 48 is well-known and thus the detailed description thereof will be omitted.

The position of the heat pump 40 may be variable, not limited. It is preferred that the heat pump 40 is provided in a device chamber 20 provided in a lower rear surface of the cabinet 2. The device chamber 20 is partitioned into a first chamber 22, a second chamber 24 and a third chamber 26. The compressor 42 and the expansion part 46 may be installed in the first chamber 22. The condenser 44 and the evaporator 48 may be installed in the second chamber 24. A steam generator 60 provided in a moisture injection unit, which will be explained later, may be installed in the first chamber 22. A water supply source 80 and a pump 70, which will be explained later, may be installed in the third chamber 26.

By the way, an inlet 34 that communicates with the cabinet 2 is provided at a front surface of the second chamber 24. A rear surface of the second chamber 24 communicates with a path 30 to supply the relatively low temperature air heat-exchanged and produced at the condenser 44 to the cabinet 2. It is preferred that a fan 50 or a blower is provided at a predetermined portion inside the path 30 and that a plurality of outlets 32 are provided at predetermined portions of a rear part of the path 30 to communicate with the inside of the cabinet 2. The path 30 may be formed along a rear and side surface of the cabinet.

The air that is heat-exchanged with the laundry inside the cabinet 2 to be low temperature and damp air (hereinafter, heat-exchanged air) is supplied to the second chamber 24 through the inlet 34 and thus it is heat-exchanged inn the condenser 44 to be relatively low temperature that is high temperature dry air higher than 50° C. The relatively low temperature passes the path 30 and it is re-supplied to the cabinet 2.

That is, although the heat-exchanged air may be exhausted outside, it is preferred that the heat-exchanged air is circulated through the cabinet 2 and the heat pump 40. At this time, the air drawn through the inlet 34 is heat-exchanged with the laundry inside the cabinet 2 and the air becomes damp with moisture of the laundry. It is preferred to remove the moisture of the damp air rather than to supply and heat the damp air at the condenser 44. While it is possible to use an auxiliary dehumidifier, it is convenient to dehumidify the air by using the evaporator 48 of the heat pump 40. That is, the evaporator 48 is placed near the inlet 34 and thus the heat-exchanged air passes the evaporator 48 to condense the moisture contained in the heat-exchanged air at a surface of the evaporator 48. As a result, the heat-exchanged air is dehumidified. Although it is possible to collect the water condensed at the evaporator 48 in an auxiliary water box, it is preferred that a water supply source 80 of a moisture injection unit which will be explained later may be used as a condensed water box.

A moisture injection unit may be provided in the cabinet 2 of the dryer to supply moisture to the cabinet 2 and the moisture is corpuscular. Specifically, the moisture injection unit atomizes water and it supplies the atomized water to the laundry placed within the cabinet 2. For example, the moisture injection unit may be a steam generator that heats water to generate steam or a device that atomizes water by using ultrasonic transducer or press spray, which will be called together as moisture injection unit. As follows, a steam generator will be presented as moisture injection unit on convenience sake.

The reason why the moisture injection unit is used will be described. Typically, laundry that is washed and spun are introduced in a dryer. According to a principle of washing, the laundry has wrinkles after being washed and the wrinkles are not removed in a conventional drying process. Based on the inventor s study, wrinkles may be removed efficiently if moisture is continuously supplied to the laundry during the overall drying process. In case that clothes are kept or used rather than laundries, wrinkles, crushing and folded marks (hereinafter, they are referenced to as wrinkles) may remain on the clothes. Above wrinkles may be removed if moisture is supplied during the drying process. In addition, if moisture is supplied to the laundry, there are advantageous effects of preventing static electricity and bad smell as well as the effect of removing wrinkles.

The moisture injection unit includes a water supply source 80 and a steam generator 60. The steam generator 60 heats water that is supplied from the water supply source 80 to generate steam. A pump 70 may be provided between the water supply source 80 and the steam generator 60. The water supply source 80 may be an external faucet. However, it is preferred that a water tank is used as the water supply source. The water tank is detachable and holds water therein.

As mentioned above, the water supply source 80 and the pump 70 may be installed in the third chamber 26. The steam generator 60 may be installed in the first chamber 22. A steam path 62 is connected to the steam generator 60 and a plurality of spray holes 61 are provided at the steam path 62 to communicate with the cabinet 2. The spray hole 61 is positioned at only an upper and side surface of the cabinet 2 in FIG. 2 but it is not limited thereto. The spray hole 61 may be provided at a lower surface of the cabinet 2 and it is preferred that the spray hole 61 is provided in at least one of the upper, side and lower surface of the cabinet 2.

The water supply source 80 is provided adjacent to the evaporator 48 to collect the water condensed at the surface of the evaporator 49. The water supply source 80 may be employed as a condensed water box, which makes the structure of the dryer much simpler.

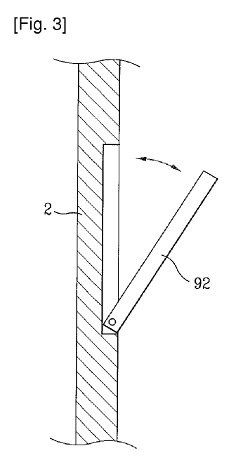

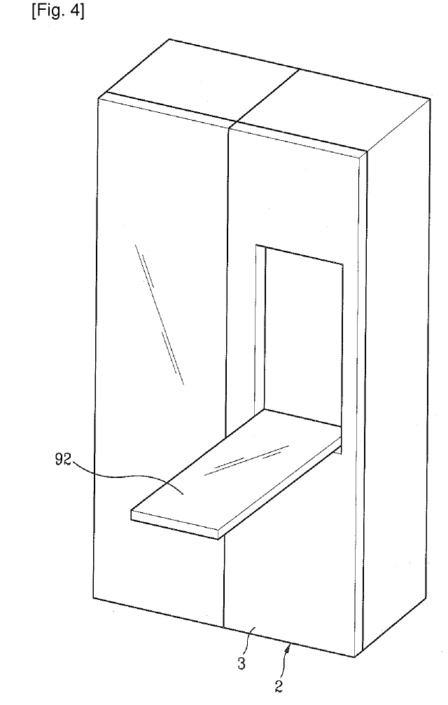

As shown in FIG. 1, an ironing unit 90 may be provided in at least one of an inside and outside of the cabinet 2. The ironing unit 90 may be installed inside the cabinet 2 (see FIG. 3) or on a front surface of the door 3 of the cabinet 2 (see FIG. 4). While, the ironing unit 90 may be a simple plate 92 and an auxiliary iron may be used. A roller or a press is installed on the plate 92 to be automatic or semi-automatic.

On the other hand, the cabinet 2 may be a module-type that can selectively combines plural modules.

In reference to FIG. 2, an operational method of the dryer according to the present invention will be explained.

Once introducing the laundry 9, for example, dehydrated clothes or temporarily used clothes in the cabinet 2, a user starts the dryer. Here, the laundry 9 is placed inside the cabinet 2, being secured by using hangers 7. When the dryer is operated, the steam generator 60 is operated. That is, the heater (not shown) of the steam generator 60 is operated to heat water and steam is generated. The steam passes the steam path 62 and it is sprayed inside the cabinet 2 through the spray holes 61. Commonly, steam is not generated as soon as the heater is operated. Steam is generated in a predetermined time period after the heater is operated and the amount of steam may increase as time passes. When the laundry is damp enough, the steam generator 60 is stopped. In this step, it is preferred that the heat pump 40 is not operated.

Hence, the heat pump 40 and the fan 50 are operated. That is, air is heat-exchanged and heated in the condenser 44. As mentioned above, the air heated in the condenser 44 is the relatively low temperature air that has a relatively lower temperature than air in the conventional dryer. The relatively low temperature air passes the path 30 and it is supplied to the cabinet 2 through the outlet 32. Hence, the air is heat-exchanged with the laundry 9 inside the cabinet 2 to dry the laundry 9. As a result, the relatively low temperature air is changed into low temperature damp air (that is the heat-exchanged air). The heat-exchanged air is drawn through the inlet 34 and passes the evaporator 48 to be condensed. The air is changed into dry air and it becomes high temperature dry air at the condenser 44 again to be supplied to the cabinet 2. At this time, the water condensed at the evaporator 48 is collected in the water supply source 80 and it is supplied to the steam generator 60 by the pump 70.

According to the present invention, the laundry 9 is dried, being secured in the cabinet 2. As a result, damage to the laundry caused by friction may be prevented and lint is also prevented. In addition, the laundry 9 is dried by the relatively low temperature air. As a result, damage to the laundry caused by a high temperature air may be prevented.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

### INDUSTRIAL APPLICABILITY

The dryer and the controlling method of the dryer according to the present invention may have following industrial applicability.

First, the laundry is dried by the relatively low temperature air, compared with the conventional dryer. As a result, damage to the laundry may be prevented, which might occur in the conventional dryer.

Furthermore, the laundry is dried, being secured in the cabinet by using hangers. As a result, damage to fabric may be prevented, which might occur because of friction between the drum and the laundry or friction between the laundries. It is possible to dry delicate fabric such as knit, dress shirts and luxurious clothes and to prevent lint caused by friction from being produced.

A still further, pipes are not necessary that are used in a gas-type dryer and thus the structure of the dryer according to the present invention may be simple. In addition, energy may be saved, compared with an electric heater used in an electricity-type dryer.

A still further, wrinkles that might be produced in the laundry after being dried may be prevented or removed efficiently. According to the present invention, wrinkles or crushing of fabric that remains after being dried may be also removed without additional ironing. In addition, it is possible to sterilize and to remove bad smell.

1. A dryer comprising:
a cabinet in which laundry is placed;
a low temperature air generation unit that generates relatively low temperature air supplied to the cabinet to dry the laundry; and
a path through which the relatively low temperature air is supplied to the cabinet.

2. The dryer as claimed in claim 1, wherein the relatively low temperature air is heated at the temperature of 50 to 75° C.

3. The dryer as claimed in claim 1, wherein the laundry is placed in the cabinet in a state of being secured.

4. The dryer as claimed in one of claims 1 to 3, wherein the low temperature air generation unit is a heat pump.

5. The dryer as claimed in claim 4, wherein the relatively low temperature air is circulated through the cabinet and the heat pump, further wherein the air that is heat-exchanged with the laundry in the cabinet (the heat-exchanged air) passes an evaporator provided in the heat pump.

6. The dryer as claimed in claim 4, further comprising a moisture injection unit that supplies moisture to the cabinet.

7. The dryer as claimed in claim 6, wherein the water injection unit comprises,
a water supply source, and
a steam generator that generates steam from water supplied from the water supply source to supply the steam to the cabinet.

8. The dryer as claimed in claim 7, wherein water condensed at the evaporator is supplied to the water supply source.

9. The dryer as claimed in claim 7, further comprising a plurality of spray holes through which the steam generated by the steam generator is sprayed inside the cabinet.

10. The dryer as claimed in claim 9, wherein the spray holes are formed in at least one of an upper surface, a side surface and a lower surface inside the cabinet.

11. The dryer as claimed in one of claims 1 to 3, wherein an ironing unit is provided in at least one of an inside and outside of the cabinet.

12. The dryer as claimed in one of claims 1 to 3, wherein the cabinet is a module type that selectively combines plural modules.

13. A controlling method of a dryer comprising:
generating relatively low temperature air; and
drying laundry by using the relatively low temperature air.

14. The controlling method of the dryer as claimed in claim 13, wherein the laundry is dried in a state of being secured when drying the laundry by using the relatively low temperature air.

15. The controlling method of the dryer as claimed in claim 13, further comprising: spraying moisture to the laundry.
